(19) United States
(12) Patent Application Publication
(10) Pub. No.: US 2024/0360695 A1
(43) Pub. Date: Oct. 31, 2024

(54) A ROUTER JIG

(71) Applicant: SCRIBEMASTER LIMITED, Dover (GB)

(72) Inventor: Colin DAVEY, Dover (GB)

(73) Assignee: SCRIBEMASTER LIMITED, Dover (GB)

(21) Appl. No.: 18/577,371

(22) PCT Filed: Jul. 7, 2022
(86) PCT No.: PCT/EP2022/069008

§ 371 Date: Jan. 8, 2024

(30) Foreign Application Priority Data
Jul. 7, 2021 (GB) 2109788.6

(51) Int. Cl. E05B 17/06; B27C 5/10

(52) U.S. Cl. CPC E05B 17/06; B27C 5/10

(57) ABSTRACT

A router jig kit for cutting two aligned slots in a surface, the jig kit comprising a housing, a first insert element and a second insert element, wherein the housing defines an insert slot which extends through the housing and is open at both ends; the first insert element forms a friction fit within the insert slot and is removeable therefrom; the second insert element forms a friction fit within the insert slot and is removeable therefrom; the first insert element defines a first router channel therethrough, wherein the first router channel has a first cross-sectional area; the second insert element defines a second router channel therethrough, wherein the second router channel has a second cross-sectional area; the first cross-sectional area is greater than the second cross-sectional area; and wherein the housing includes a coupling element via which the housing is detachably coupled to a substrate.

The present invention relates to a router jig, for example a router jig that can be used in connection with the installation of sash window locking assemblies.

It has come to light recently that sash window pose a safety hazard for young children, as they can be relatively easy to open and there is a risk that once open, a child may fall from the window.

In order to address this issue, it has been proposed to fit safety locks to sash windows which limit the amount they are able to open in normal circumstances. It is currently recommended that the safety locks limit the opening of sash windows to 4 inches or less when the locks are in operation.

Such safety locks are typically installed on an inwardly facing surface of one of the sash frames and are positioned to limit the amount by which each of the sashes can open to a predetermined distance (e.g. 4 inches).

The fitting of the safety lock assembly requires a first slot to be cut into the sash frame to accommodate the safety lock mechanism and a second slot to be cut into the sash frame to accommodate the escutcheon plate of the safety lock. It will be appreciated that the first and second slots must be precisely aligned with each other and with the other sash frame such that the lock may be fitted into the slots and that the lock is correctly located to permit only the desired amount of movement of one sash relative to the other sash.

According to a first aspect of the invention, there is provided a router jig kit for cutting two aligned slots in a surface, the jig kit comprising a housing, a first insert element and a second insert element, wherein the housing defines an insert slot which extends through the housing and is open at both ends; the first insert element forms a friction fit within the insert slot and is removeable therefrom; the second insert element forms a friction fit within the insert slot and is removeable therefrom; the first insert element defines a first router channel therethrough, wherein the first router channel has a first cross-sectional area; the second insert element defines a second router channel therethrough, wherein the second router channel has a second cross-sectional area; the first cross-sectional area is greater than the second cross-sectional area; and wherein the housing includes a coupling element via which the housing is detachably coupled to a substrate.

The router jig kit of the invention permits a user to secure the housing to a suitable substrate. The user can then rout out a first slot in the surface by inserting the first insert element into the housing and using the first router channel as a guide for the router cutter. The first insert element may then be removed from the housing and replaced with the second insert element. A second slot may then be formed in the surface using a router and the second router channel as a guide for the router.

In an embodiment of the invention, the coupling element is a through bore which receives therein a fixing. Thus, the housing may be detachably coupled to a substrate via a fixing which passes through the bore. For example, the fixing may be a screw.

As noted previously, the router jig kit of the invention may be used when cutting slots in sash window frames. In such embodiments, it may be desired to secure the jig housing to a side rail of the window frame adjacent to where it is desired to cut the slots. Accordingly, it may be desired to secure the jig housing to a substrate that is perpendicular to the surface in which the slots are to be cut. In view of this, the through bore may be arranged perpendicularly to the longitudinal axis of the insert slot.

The first and second router channels may have a depth (i.e., a dimension in a direction parallel to the longitudinal axis of the channel) that is greater than the normal depth of a router cutter bit. In order to address this issue, the router jig kit may include a router cutting bit extension arm. The extension arm is suitably disposed between the cutting bit and a router in order to extend the distance that the cutting bit extends from the router.

Suitably, the router cutting bit extension arm includes a cutter receiver at one end thereof. In this way, the extension arm may be secured to the router and a suitable cutting bit may be received by the cutter receiver. The cutter receiver is suitably located at a distal end of the extension arm.

It will be appreciated that the greater the distance between the cutting bit and the router, the greater the chance the cutting bit will move laterally relative to the rotational axis defined by the router. This is known as “wobble”. In order to minimise the risk of such lateral displacement of the cutting bit relative to the rotational axis defined by the router, the router cutting bit extension arm may include an elongate shaft and a bearing, wherein the elongate shaft rotates within the bearing. In this way, the bearing may be supported such that the lateral displacement of the cutting bit is minimised.

The extension arm may be supported within a sleeve. Thus, the jig kit may further include an extension arm guide sleeve, wherein the router cutting bit extension arm is disposed within the guide sleeve. In embodiments in which the extension arm includes an elongate shaft and a bearing, the bearing may be supported within the sleeve. The sleeve is suitably secured to a router and the longitudinal axis of the sleeve arranged to be coaxial with the rotational axis of the router.

According to a second aspect of the invention, there is provided a router jig kit for cutting two aligned slots in a surface, the jig kit comprising a jig assembly including a first jig wall; a second jig wall which is spaced from the first jig wall; and a pair of connecting walls which connect the first and second jig walls, wherein the jig assembly has a rectangular configuration; wherein the first jig wall defines a first router aperture which has a first cross-sectional area; the second jig wall defines a second router aperture which has a second cross-sectional area; the first cross-sectional area is greater than the second cross-sectional area; the first router aperture is aligned with the second router aperture; and wherein at least one of the connecting walls includes a coupling element via which the jig assembly is detachably coupled to a substrate.

The router jig of the second aspect of the invention allows a user to secure the assembly in a first orientation to a substrate perpendicular to the surface in which the slots are to be cut via the or each coupling element. A router can then be located on an outwardly facing surface of the second jig wall and the router bit extends through both the second and first router apertures. A first slot can then be cut into the surface. The user can then release the jig assembly from the substrate, rotate it through 180° or otherwise invert the jig assembly and then re-secure it to the substrate in a second orientation. In this orientation, the router can then be located on an outwardly facing surface of the first jig wall and the router bit extends through the first and second router apertures such that the user can cut the second slot around the first slot. It will be appreciated that the jig assembly may be aligned with a datum surface (e.g. an upper or lower end of the other sash) prior to securing the jig assembly in place to ensure that the first and second slots are correctly aligned and spaced from the datum surface. For example, when the jig assembly is used to cut slots in sash windows, the jig assembly may be aligned with a side substrate defined by the runners within which the sashes slide and with a datum surface defined by the upper or lower end surface of the other sash window. This ensures that the two slots are precisely aligned and allow for the correct placement of the lock assembly.

It will be appreciated that the second router aperture is suitably different to the first router aperture.

According to the invention, the first and second jig walls are parallel to each other. This helps to ensure the correct alignment of the first and second router apertures.

Suitably, the first router aperture defines a first longitudinal axis; the second router aperture defines a second longitudinal axis; and the first and second axes are located on a common plane which is perpendicular to first and second jig walls. This allows for the slots cut using the first and second router apertures to be correctly aligned.

In a further embodiment of the invention, the first jig wall defines a pair of identical first router apertures; and the second jig wall defines a pair of identical second router apertures. This allows for easier use when slots need to be cut into both left and right hand sides of components (e.g. sash window frames). For example, the left hand router apertures can be used to cut the slots in the left hand side of the component and the right hand router apertures can be used to cut the slots in the right hand side of the component.

In such embodiments, one of the pair of first router apertures may be aligned with one of the pair of second router apertures along a first plane perpendicular to the opposed jig walls; and the other of the pair of first router apertures may be aligned with the other of the pair of second router apertures along a second plane perpendicular to the opposed jig walls.

As noted above, the coupling element may comprise a through hole. In such embodiments, a screw or similar fixing may be used to secure the router jig assembly to the substrate via the through hole. By having the coupling element carried by or defined by the connecting walls, the fixings may be secured to a substrate which is largely not visible in use, for example, the router jig assembly may be secured to one of the side channels within which the sashes slide.

The connecting walls may define a plurality of coupling elements. In such embodiments, a single one of the coupling elements may be selected via which the router jig assembly may be secured to a substrate or more than one coupling element may be selected in order to secure the router jig assembly.

As noted above, it will be appreciated that the spacing between the first and second jig walls may result in conventional router cutting bits being too short to extend through both jig walls. Accordingly, in embodiment of the second aspect of the invention, the router jig kit may include an extension arm as defined anywhere hereinabove in connection with the first aspect of the invention. The router jig kit of the second aspect of the invention may further include a guide sleeve as defined and discussed hereinabove.

According to a third aspect of the invention, there is provided a method of cutting two aligned slots in a surface, the method comprising:
Providing a router jig kit as defined anywhere herein in connection with the first aspect of the invention;
Securing the housing to a substrate via the or each coupling element;
Inserting a first insert element into the insert slot of the housing;
Cutting a first slot in the surface which is defined by the first router channel;
Removing the first insert element from the insert slot of the housing and inserting the second insert element in the insert slot of the housing;
Cutting a second slot in the surface which is defined by the second router channel; and
Detaching the housing from the substrate.

The method of the third aspect of the invention may include the step of coupling a cutting bit to a router via an extension arm, wherein the extension arm may as defined anywhere hereinabove. It may further include the step of attaching a guide sleeve to the router and locating the extension arm within the guide sleeve, wherein the guide sleeve may be as defined anywhere hereinabove.

According to a fourth aspect of the invention, there is provided a method of cutting two aligned slots in a surface, the method comprising:
providing a router jig kit as defined anywhere herein in connection with the second aspect of the invention;
securing the router jig to a substrate via the or each coupling element;
cutting a first slot which is defined by the respective first or second router aperture;
detaching the router jig from the substrate;
re-orienting the router jig such that the other of the first and second jig walls is in contact with the surface;
re-securing the router jig to the substrate via the or each coupling element; and
cutting a second slot which is defined by the other of the first and second router aperture.

As with the third aspect of the invention, the method of the fourth aspect of the invention may include the step of coupling a cutting bit to a router via an extension arm, wherein the extension arm may as defined anywhere hereinabove. It may further include the step of attaching a guide sleeve to the router and locating the extension arm within the guide sleeve, wherein the guide sleeve may be as defined anywhere hereinabove.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

Embodiments of the invention will now be described, by way of example only, with reference to the accompanying drawings in which:

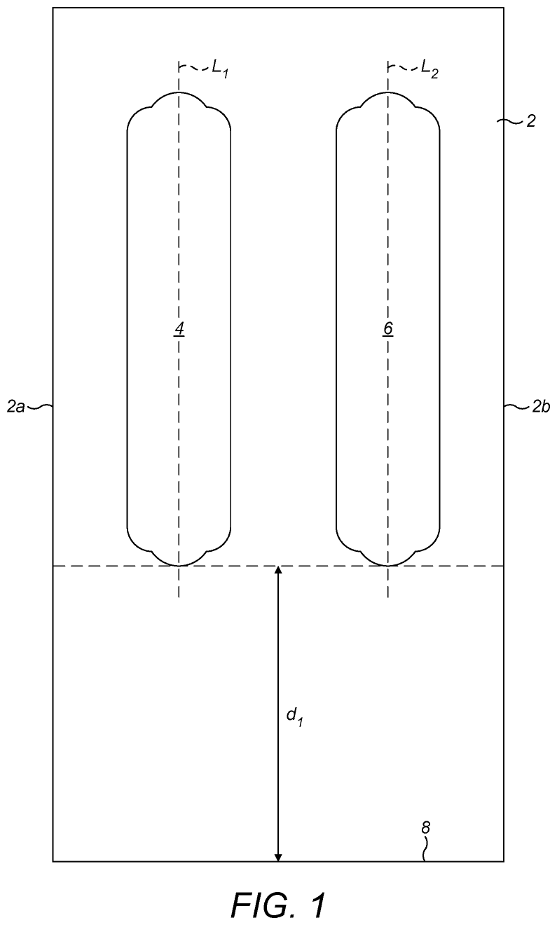

FIG. 1 is a plan view from above of a first jig wall which forms part of a router jig according to the second aspect of the invention;

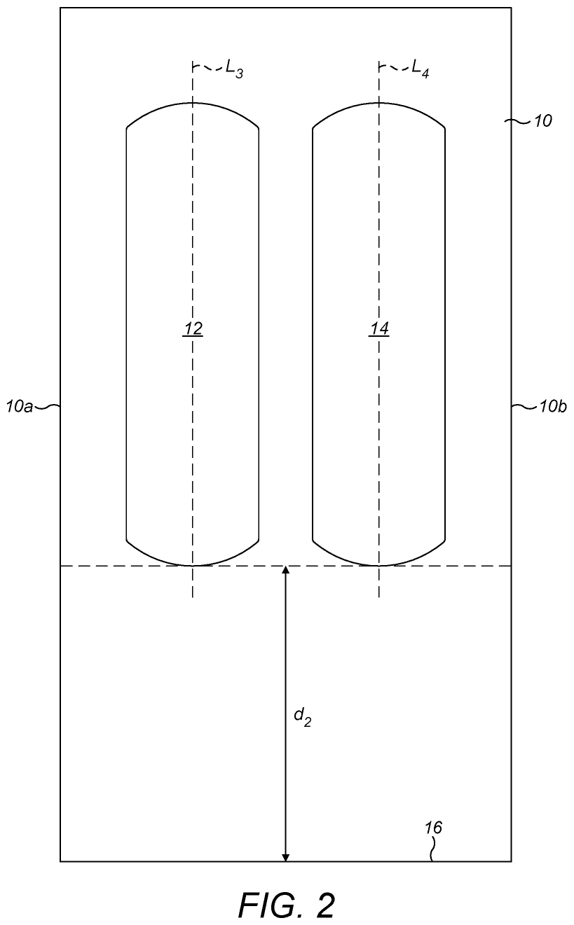

FIG. 2 is a plan view from above of a second jig wall which forms part of the router jig according to the second aspect of the invention;

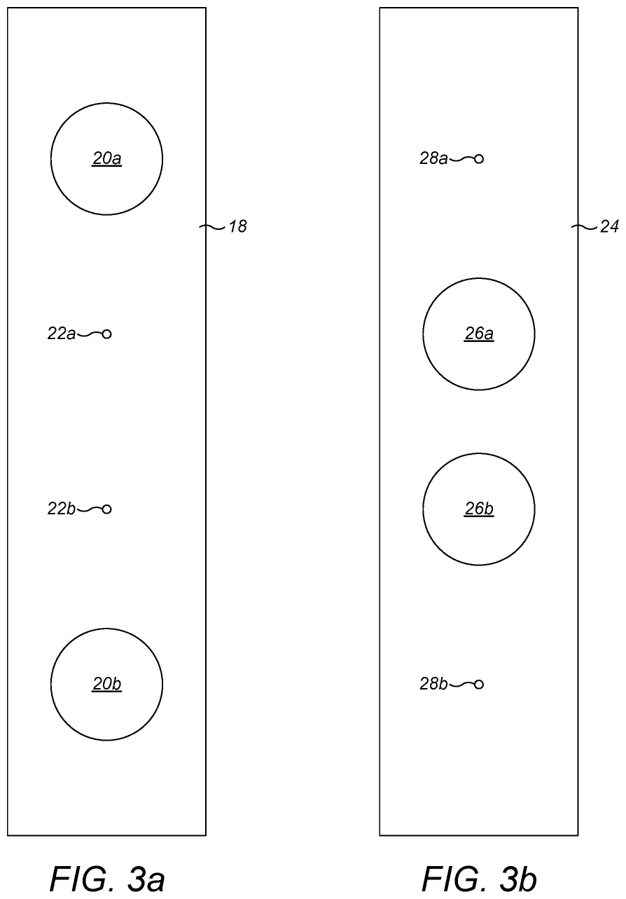

FIG. 3a is a plan view from above of a first connecting wall which forms part of the router jig shown in FIGS. 1 and 2;

FIG. 3b is a plan view from above of a second connecting wall which forms part of the router jig shown in FIGS. 1 and 2;

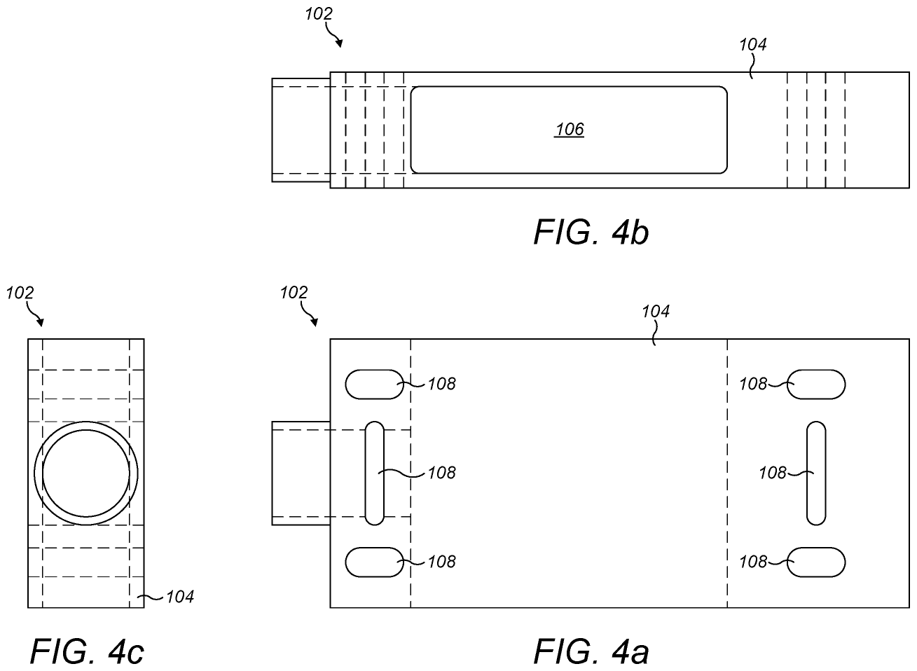

FIGS. 4a to 4c show projections of a router jig housing according to the second aspect of the invention;

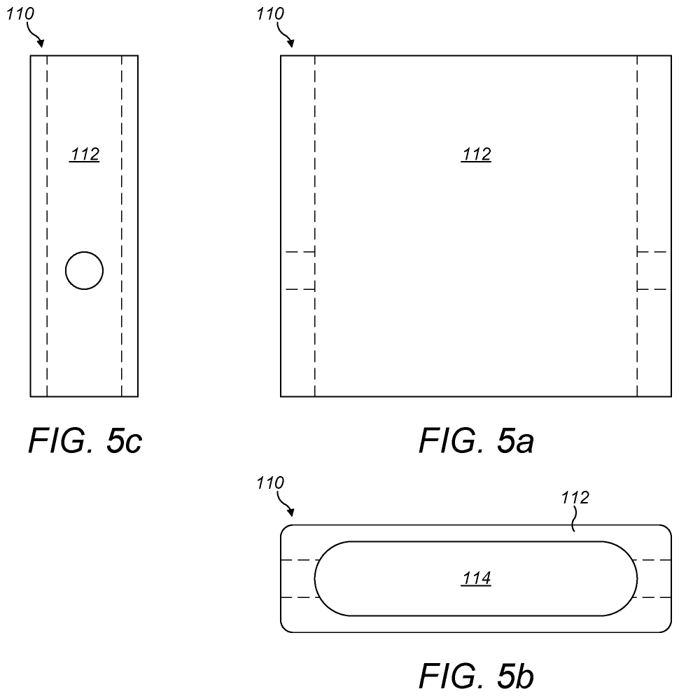

FIGS. 5a to 5c show projections of a first insert element for use with the housing shown in FIGS. 4a to 4c;

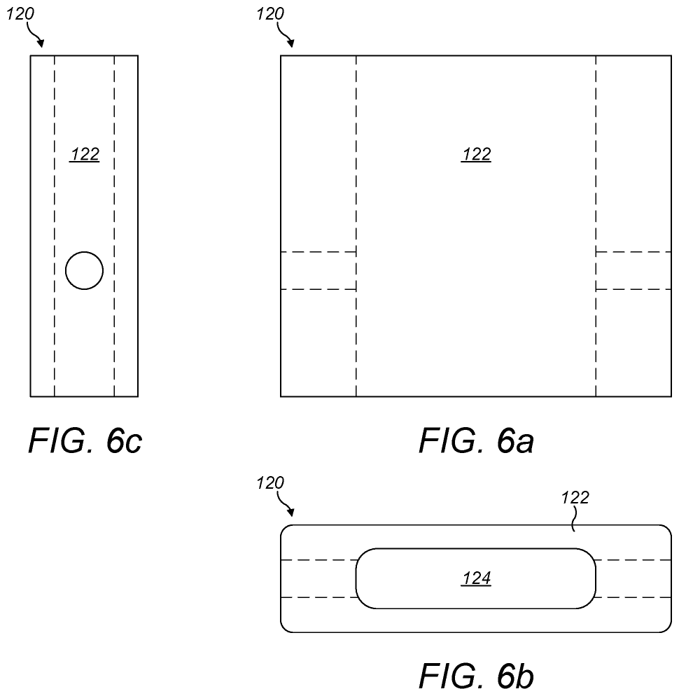

FIGS. 6a to 6c show projections of a second insert element for use with the housing shown in FIGS. 4a to 4c;

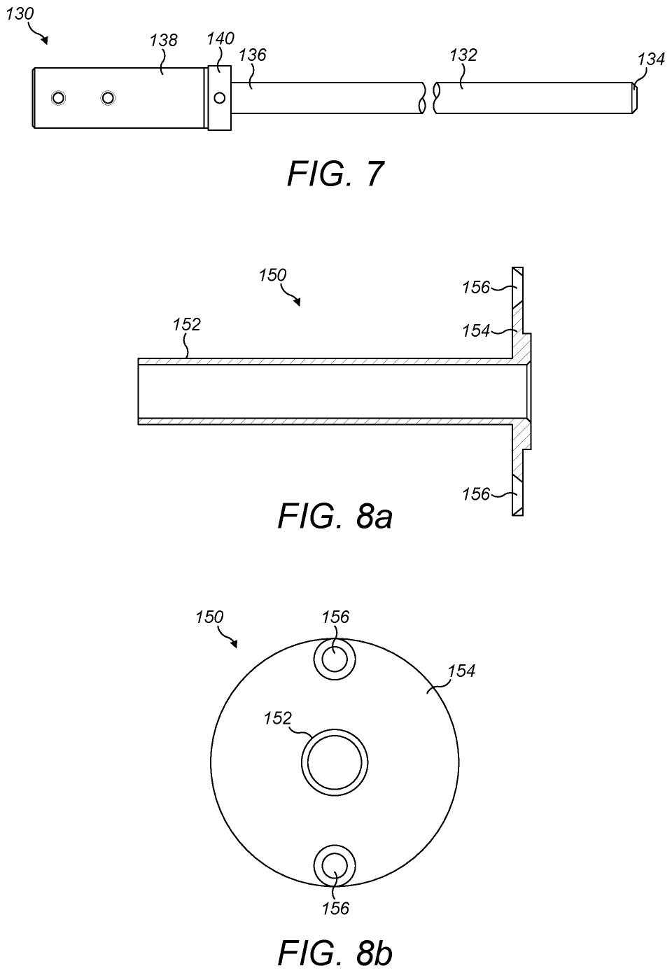

FIG. 7 shows an extension arm that forms part of the router jig kit of the second aspect of the invention; and

FIGS. 8a and 8b show a guide sleeve that forms part of the router jig kit of the second aspect of the invention.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a first jig wall 2 which forms part of the router jig according to the second aspect of the invention. The first jig wall 2 defines a first router aperture 4 and a second router aperture 6, wherein the first and second router apertures 4, 6 are identical in size and shape.

The first router aperture 4 defines a longitudinal axis L1, which is spaced from a left side edge 2a by the same distance that a longitudinal axis L2 defined by the second router aperture 6 is spaced from a right side edge 2b. Additionally, bottom portions of the first and second router apertures 4, 6 are both spaced from a first contact surface 8 of the first jig wall 2 by the pre-defined distance d1.

FIG. 2 shows a second jig wall 10 which also forms part of the router jig according to the second aspect of the invention. The second jig wall 10 is similar to the first jig wall 2. However, the second jig wall 10 defines a first router aperture 12 which defines a longitudinal axis L3 and a second router aperture 14 which defines a longitudinal axis L4. The first and second router apertures 12, 14 defined by the second jig wall 10 are different in shape and size to the first and second router apertures 4, 6 defined by the first jig wall 2. However, the longitudinal axis L3 is spaced from a left side edge 10a of the second jig wall 10 by the same distance that the longitudinal axis L4 is spaced from a right side edge 10b of the second jig wall 10 and the same distance that the longitudinal axis L1 is spaced from the left side edge 2a of the first jig wall 2. Thus, the spacing of the longitudinal axes L1, L2, L3 and L4 from their respective side edges 2a, 2b, 10a, 10b is the same. In this way, the first router apertures 4, 12 are aligned with each other and the second router apertures 6, 14 are aligned with each other.

As can also be seen from FIG. 2, bottom portions of the first and second router apertures 12, 14 are both spaced from a first contact surface 16 of the second jig wall 10 by the pre-defined distance d2.

The first side edge 2a of the first jig wall 2 and the first side edge 10a of the second jig wall 10 are connected by a first connecting wall 18 shown in FIG. 3a; and the second side edge 2b of the first jig wall 2 and the second side edge portion 10b of the second jig wall 10 are connected by a second connecting wall 24 shown in FIG. 3b. In this way, the first and second jig walls 2, 10 are arranged to be parallel and the router jig has a rectangular cross-section.

The first connecting wall 18 defines upper and lower large diameter through bores 20a, 20b and a pair of centrally located screw holes 22a, 22b, where the screw holes 22a, 22b have a smaller diameter than the large diameter bores 20a, 20b.

The second connecting wall 24 has the opposite configuration of bores, namely upper and lower screw holes 28a, 28b and centrally located large diameter bores 26a, 26b.

The skilled person will appreciate that each screw hole 22a, 22b, 28a, 28b is aligned with a respective large diameter bore 20a, 20b, 26a, 26b. In this way, each large diameter bore 20a, 20b, 26a, 26b permits a screwdriver to pass therethrough which can be used to screw or unscrew a screw into or out from a substrate, wherein the screw is located within the respective screw hole 22a, 22b, 28a, 28b.

In use, the router jig is positioned with the second jig wall 10 adjacent to a surface to be cut (e.g. one side of a sash window frame), the first contact surface 16 in contact with a datum surface (e.g. the top of an adjacent sash window frame), and one of the connecting walls 18, 24 in contact with a side wall substrate which is arranged perpendicular to the surface to be cut (e.g. a side channel within which the sash window frames slide). It is then screwed in place by one or two screws which are inserted through the respective screw holes 22a, 22b, 28a, 28b and tightened by a screwdriver inserted through the respective large diameter bore 20a, 20b, 26a, 26b on the opposite joining wall 18, 24.

A router may then be engaged with an outwardly facing surface of the first jig wall 2, with the router bit passing through first router apertures 4, 12 or through the second router apertures 6, 14. The first cut is then made with the router bit being guided by the periphery of the first or second router apertures 4, 6.

Once the first cut has been made, the router jig is removed from the substrate by unscrewing the screw(s) and is flipped through 180°. It is then re-positioned with the first jig wall 2 adjacent to the surface to be cut, the first contact surface 8 in contact with the datum surface, and one of the connecting walls 18, 24 in contact with the side wall substrate. It is then re-screwed in place by one or two screws which are inserted through the respective screw holes 22a, 22b, 28a, 28b and tightened by a screwdriver inserted through the respective large diameter bore 20a, 20b, 26a, 26b on the opposite connecting wall 18, 24.

A router may then be engaged with an outwardly facing surface of the second jig wall 10, with the router bit passing through second router apertures 14, 6 or through the first router apertures 12, 4. The second cut is then made with the router bit being guided by the periphery of the first or second router apertures 12, 14.

The router jig may then be removed for the second time and the first and second cuts formed in the surface are ready to receive therein a safety lock apparatus.

FIGS. 4 to 8 show a second embodiment of the invention.

FIGS. 4a to 4c show a housing 102 which forms part of the router jig kit according to the second aspect of the invention.

The housing 102 includes a housing body 104 which defines therethrough an insert slot 106. The slot 106 is open at both ends. The insert slot 106 defines a longitudinal axis. The housing body 104 further defines a number of screw slots 108 which are arranged perpendicular to the longitudinal axis of the insert slot 106. In this way, the housing may be secured to a substrate which is perpendicular to the surface in which the slots are to be cut.

FIGS. 5a to 5c show a first insert element 110 which may be inserted into the insert slot 106. The first insert element 110 includes an insert element body 112 which defines therethrough a first router channel 114. The router channel 114 defines a cross-sectional area of Xmm². The insert element body 112 is sized to form a friction fit within the insert slot 106 of the housing body 104. FIGS. 6a to 6c show a second insert element 120 which may be inserted into the insert slot 106. The second insert element 120 includes an insert element body 122 which defines therethrough a second router channel 124. The second router channel 124 defines a cross-sectional area of Ymm². The insert element body 122 is sized to form a friction fit within the insert slot 106 of the housing body 104. It will be noted that the value of X is greater than the value of Y.

FIG. 7 shows an extension arm 130 which forms part of the router jig kit of the second aspect of the invention. The extension arm allows for the router cutting bit to pass through the first and second router channels 114, 124 and contact the surface in which the slots are to be cut.

The extension arm 130 includes an elongate shaft 132. The elongate shaft 132 has a proximal end 134 which is secured to a conventional router (not shown) in the normal way. At a distal end 136 of the elongate shaft 132 is secured a router cutting bit holder 138. The cutting bit holder 138 receives therein and retains a router cutting bit (not shown). It is well known how to retain cutting bits in cutting bit holders. Accordingly, this will not be described in detail herein.

Finally, a bearing 140 is disposed on the elongate shaft 132 adjacent to the cutting bit holder 138. The elongate shaft 132 is able to rotate within the bearing 140.

FIGS. 8a and 8b show a guide sleeve 150 which in use is secured to a router. The guide sleeve 150 includes an elongate cylindrical body 152 at one end of which is carried a flange 154. The flange 154 defines two screw holes 156 via which the flange is secured to a router body.

The cylindrical body 152 is arranged to be coaxial with the rotational axis of the router. In use, the extension arm 130 is disposed within the elongate cylindrical body 152 with the bearing 140 contacting the inwardly facing surface of the cylindrical body 152 and the elongate shaft 132 rotating within the cylindrical body. In this way, the cylindrical body 152, which is secured to the router via the flange 154 supports the bearing 140. The bearing 140 in turn supports the elongate shaft 132. This minimises any lateral displacement of the cutting bit holder 138 in use.

In use, the housing 102 is secured to a suitable substrate via screw which pass through one or more of the screw slots 108. When the housing 102 is secured in the desired position, the first insert element 110 is inserted into the insert slot 106.

The extension arm 130 is secured at its proximal end 134 to a router and a cutting bit is located within the cutting bit holder 138. A guide sleeve 150 is then located over the extension arm 130 and secured to the router via the screw holes 156 defined by the flange 154. The elongate shaft 132 is located within the cylindrical body 152 of the guide sleeve 150, together with the bearing 140. The bearing 140 engages the inwardly facing surface of the cylindrical body 152 and is supported thereby.

The guide sleeve 150 is then disposed within the first router channel 114 and a slot is cut in a surface located below the housing 102 as normal.

The router is then removed and the first insert element 110 is replaced with the second insert element 120. The process of cutting the second slot is then repeated as described above.

Once both slots have been cut by the router, the housing 102 is removed from the substrate.

The skilled person will appreciate that different guide sleeves may be used, depending on the router being used. Additionally, alternative extension arms may be used, depending on the cutting bit to be used and the router to be used.

1-15. (canceled)

16. A router jig kit for cutting two aligned slots in a surface, the jig kit comprising:
a housing;
a first insert element; and
a second insert element;
wherein the housing defines an insert slot which extends through the housing and is open at both ends;
wherein the first insert element forms a friction fit within the insert slot and is removeable therefrom;
wherein the second insert element forms a friction fit within the insert slot and is removeable therefrom;
wherein the first insert element defines a first router channel therethrough;
wherein the first router channel has a first cross-sectional area;
wherein the second insert element defines a second router channel therethrough;
wherein the second router channel has a second cross-sectional area;
wherein the first cross-sectional area is greater than the second cross-sectional area; and
wherein the housing includes a coupling element via which the housing is detachably coupled to a substrate.

17. The router jig kit according to claim 16, wherein the coupling element is a through bore which receives therein a fixing.

18. The router jig kit according to claim 17, wherein the through bore is arranged perpendicularly to the insert slot.

19. The router jig kit according to claim 16, wherein the jig kit further includes a router cutting bit extension arm.

20. The router jig kit according to claim 19, wherein the router cutting bit extension arm includes a cutter receiver at one end thereof.

21. The router jig kit according to claim 19, wherein:
the router cutting bit extension arm includes an elongate shaft and a bearing; and
the elongate shaft rotates within the bearing.

22. A router jig kit according to claim 19, wherein:
the jig kit further includes an extension arm guide sleeve; and
the router cutting bit extension arm is disposed within the guide sleeve.

23. A router jig kit for cutting two aligned slots in a surface, the jig kit comprising:
a jig assembly including a first jig wall;
a second jig wall which is spaced from the first jig wall; and
a pair of connecting walls which connect the first and second jig walls;
wherein the jig assembly has a rectangular configuration;
wherein the first jig wall defines a first router aperture which has a first cross-sectional area;
wherein the second jig wall defines a second router aperture which has a second cross-sectional area;
wherein the first cross-sectional area is greater than the second cross-sectional area;
wherein the first router aperture is aligned with the second router aperture; and
wherein at least one of the connecting walls includes a coupling element via which the jig assembly is detachably coupled to a substrate.

24. The router kit according to claim 23, wherein:
the first jig wall defines a pair of identical first router apertures; and
the second jig wall defines a pair of identical second router apertures.

25. The router kit according to claim 24, wherein:
one of the pair of first router apertures is aligned with a corresponding one of the pair of second router apertures along a first plane perpendicular to the opposed jig walls; and
the other of the pair of first router apertures is aligned with the other of the pair of second router apertures along a second plane perpendicular to the opposed jig walls.

26. The router kit according to claim 23, wherein the coupling element is a through bore which receives therein a fixing.

27. The router kit according to claim 23, wherein the jig kit further includes a router cutting bit extension arm.

28. The router kit according to claim 27, wherein the router cutting bit extension arm includes a cutter receiver at one end thereof.

29. The router kit according to claim 27, wherein:
the router cutting bit extension arm includes an elongate shaft and a bearing; and
the elongate shaft rotates within the bearing.

30. The router kit according to claim 27, wherein:
the jig kit further includes an extension arm guide sleeve; and
the router cutting bit extension arm is disposed within the guide sleeve.
